(19) United States
(12) Patent Application Publication
(10) Pub. No.: US 2007/0258701 A1
(43) Pub. Date: Nov. 8, 2007

(54) Apparatus and Method for Processing Multimodal Data Broadcasting and System and Method for Receiving Multimodal Data Broadcasting

(76) Inventors: Bong-Ho Lee, Daejon (KR); Kyu-Tae Yang, Daejon (KR); So-Ra Park, Daejon (KR); Hee-Jeong Kim, Daejon (KR); Soo-In Lee, Daejon (KR)

Correspondence Address: LADAS & PARRY LLP, 224 SOUTH MICHIGAN AVENUE, SUITE 1600, CHICAGO, IL, 60604, US

(21) Appl. No.: 11/587,380

(22) PCT Filed: Apr. 19, 2005
(86) PCT No.: PCT/KR05/01112

§ 371 Date: Apr. 25, 2007

(30) Foreign Application Priority Data
Apr. 24, 2004 (KR) 10-2004-0028533

(51) Int. Cl. H04N 5/95

(52) U.S. Cl. 386/96; 386/E05.037

(57) ABSTRACT

Disclosed are an apparatus and a method for processing multimodal data broadcasting and a system and a method for receiving multimodal data broadcasting. The multimodal data broadcasting processing apparatus includes: at least one interfacing unit for receiving contents transferred from a data broadcasting server and storing the contents; a multimodal browsing unit for parsing the stored contents, classifying the contents and interpreting the classified contents to generate instructions and data necessary for running a corresponding browsing unit; a graphic browsing unit for generating a graphic output signal according to the instructions and data necessary for running the graphic browsing unit; a voice browsing unit for generating a speech output signal according to the instructions and data necessary for running the voice browsing unit; a graphic output unit for outputting graphics according to the graphic output signal; and a speech output unit for outputting speech according to the speech output signal.

### TECHNICAL FIELD

The present invention relates to an apparatus and a method for processing multimodal data broadcasting and a system and a method for receiving multimodal data broadcasting; and more particularly, to an apparatus and a method for processing multimodal web-based data broadcasting incorporated with a graphic/voice user interface and a system and a method for receiving multimodal web-based data broadcasting.

### BACKGROUND ART

In a conventional digital data broadcasting technology, data broadcasting services based on web and Java applications are provided grounded on the digital video broadcasting multimedia home platform (DVB-MHP) specification in case of a digital video broadcasting-satellite (DVB-S) system and a digital video broadcasting-handheld (DVB-h) system used for mobility and on the digital TV application and software environment (DASE)/advanced common application platform (ACAP) specification in case of a terrestrial digital broadcasting system.

A domestic digital satellite multimedia broadcasting (DMB) system follows the Japanese specification of system E. Also, web-based data broadcasting services are provided by employing the specification for the association of radio industries and business broadcast markup language (ARIB-BML). Also, for a domestic digital terrestrial multimedia broadcasting (DMB) system, the multimedia object transfer broadcasting web site (MOT BWS) specification which is based on HTML 4.0 is applied to provide web-based data broadcasting services.

Under the above described conventional data broadcasting systems and specifications, contents of the web-based data broadcasting services are defined on the basis of HTML, XHTML, bHTML or the specifications for web sites corresponding to these listed specifications in a higher or lower version. The contents of the web-based data broadcasting services are then transferred through a broadcasting network, and a receiver subsequently receives the transferred data and provides various services to users.

In respect of user interface and information providing services, the above mentioned conventional web-based data broadcasting transfers data expressed in graphics and receives requests from users through a graphic user interface (GUI). However, this sole serving of the graphic user interface for the web-based data broadcasting services may bring out inconveniency or become a threat to those users in mobile environments, for instance, users who are driving or walking or those vision-impaired people.

Also, in the conventional digital terrestrial or satellite multimedia broadcasting system for use in a mobile environment, since screens of those digital radios, digital televisions, and other types of receivers for providing various data services such as personal digital assistants (PDAs), mobile terminals, set-top-boxes (STBs) installed in vehicles are small, it is difficult to effectively communicate with users when information is constituted with graphics and texts only.

### DISCLOSURE OF INVENTION

### Technical Problem

It is, therefore, an object of the present invention to provide an apparatus and a method for processing multimodal data broadcasting incorporated with a graphic/voice user interface so that those users who are in mobile environments and vision-impaired people are able to easily access desired information via speech even without viewing a screen.

It is another object of the present invention to provide a system and a method for receiving multimodal data broadcasting with use of the apparatus and the method for processing multimodal data broadcasting.

### TECHNICAL SOLUTION

In accordance with one aspect of the present invention, there is provided a multimodal data broadcasting processing apparatus incorporating with a graphic/voice user interface for data broadcasting, the multimodal data broadcasting processing apparatus including: at least one interfacing unit for receiving contents transferred from a data broadcasting server and storing the contents; a multimodal browsing unit for parsing the stored contents, classifying the contents into a graphic part and a voice part and interpreting the classified contents to generate instructions and data necessary for running a corresponding browsing unit; a graphic browsing unit for generating a graphic output signal according to the instructions and data necessary for running the graphic browsing unit; a voice browsing unit for generating a speech output signal according to the instructions and data necessary for running the voice browsing unit; a graphic output unit for outputting graphics according to the graphic output signal; and a speech output unit for outputting speech according to the speech output signal.

In accordance with another aspect of the present invention, there is provided a multimodal data broadcasting receiving system incorporating with a graphic/voice user interface, including: a unidirectional data broadcasting receiving unit for receiving a broadcasting data from an external source, separating content data from the broadcasting data and decoding the separated content data to restore contents; a multimodal data broadcasting processing unit for classifying the contents into a voice part and a graphic part and running a corresponding graphic/voice browsing unit to output graphics/speech; and a first control unit for controlling the unidirectional data broadcasting receiving unit and the multimodal data broadcasting processing unit to provide unidirectional data broadcasting services.

In accordance with still another aspect of the present invention, there is provided a method for processing multimodal data broadcasting incorporated with a graphic/voice user interface, the method including the steps of: (a) receiving and storing contents transmitted from the a data broadcasting server; (b) parsing the stored contents, classifying the contents into a graphic part and a voice part and interpreting the classified contents to generate instructions and data necessary for running a corresponding graphic/voice browsing unit; (c) generating a graphic output signal by employing the graphic browsing unit according to the instructions and data necessary for running the graphic browsing unit; (d) generating a speech output signal by employing the voice browsing unit according to the instructions and data necessary for running the voice browsing unit; (e) outputting graphics according to the graphic output signal; and (f) outputting speech according to the speech output signal.

In accordance with further aspect of the present invention, there is provided a method for receiving multimodal data broadcasting incorporated with a graphic/voice user interface, the method including the steps of: (a) receiving a broadcasting data inputted from a unidirectional data broadcasting server, classifying the broadcasting data into content data and decoding the content data to restore contents; and (b) classifying the contents into a voice part and a graphic part and running a corresponding graphic/voice browsing unit according to the classified contents to output graphics/speech.

### ADVANTAGEOUS EFFECTS

In accordance with the preferred embodiment of the present invention, multimodal web-based content services incorporated with graphic and voice user interfaces are provided to those users in mobile environments, for instance, those who are driving or walking, or those users with vision impairment. As a result, those users are able to access desired information even without intentionally viewing or surfing a certain web page.

Also, there is another effect of providing web contents and desired information even with a user-oriented speech input. Therefore, this effect further reduces a chance of endangering those users in mobile environment or with impaired vision such as traffic accidents and provides user-friendly convenience.

Moreover, in addition to graphic-based web content services, those services such as the EPG, top news, traffic information, weather information, advertisements, local information, mobile commerce service and education service can also be provided in the form of speech as simultaneous to the graphic form.

Additionally, since customized web-based contents can be received through the bidirectional network and provided to users, it is possible to provide various bidirectional multimodal web-based data broadcasting services.

### BRIEF DESCRIPTION OF THE DRAWINGS

Other objects and aspects of the invention will become apparent from the following description of the embodiments with reference to the accompanying drawings, in which:

FIG. 1 is a configuration diagram showing a multimodal web-based data broadcasting receiving system incorporating with a graphic/voice user interface in accordance with a preferred embodiment of the present invention;

FIG. 2 is a configuration diagram showing a unidirectional data broadcasting receiving unit depicted in FIG. 1;

FIG. 3 is a configuration diagram showing a multimodal web-based data broadcasting processing apparatus depicted in FIG. 1; and

FIG. 4 is a flowchart describing a method for processing multimodal web-based data broadcasting incorporated with a graphic/voice user interface and a method for receiving multimodal web-based data broadcasting using the multimodal web-based data broadcasting processing method in accordance with the preferred embodiment of the present invention.

### BEST MODE FOR CARRYING OUT THE INVENTION

Hereinafter, an apparatus and a method for processing multimodal web-based data broadcasting and a system and a method for receiving multimodal web-based data broadcasting in accordance with a preferred embodiment of the present invention will be described in detail with reference to the accompanying drawings.

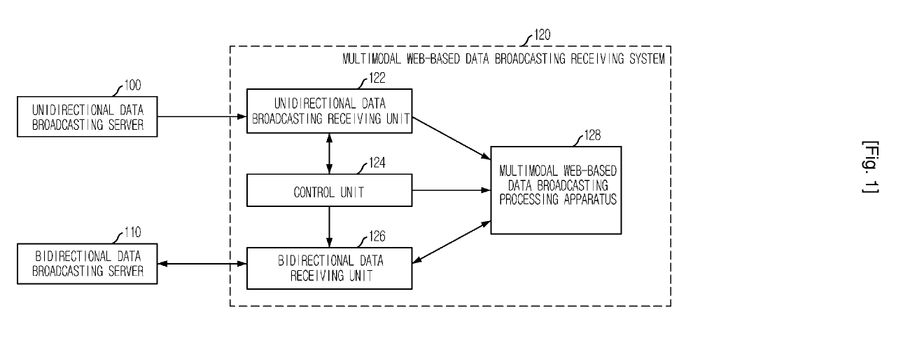

FIG. 1 is a configuration diagram showing a multimodal web-based data broadcasting receiving system incorporating with a graphic/voice user interface in accordance with the present invention.

The multimodal web-based data broadcasting receiving system 120 incorporating with a graphic/voice user interface includes: a unidirectional data broadcasting receiving unit 122; a control unit 124; a bidirectional data receiving unit 126; and a multimodal web-based data broadcasting processing apparatus 128. Herein, personal digital assistants (PDAs), mobile telecommunication terminals, set-top-boxes (STBs) for use in vehicles are examples of the web-based data broadcasting receiving system 120.

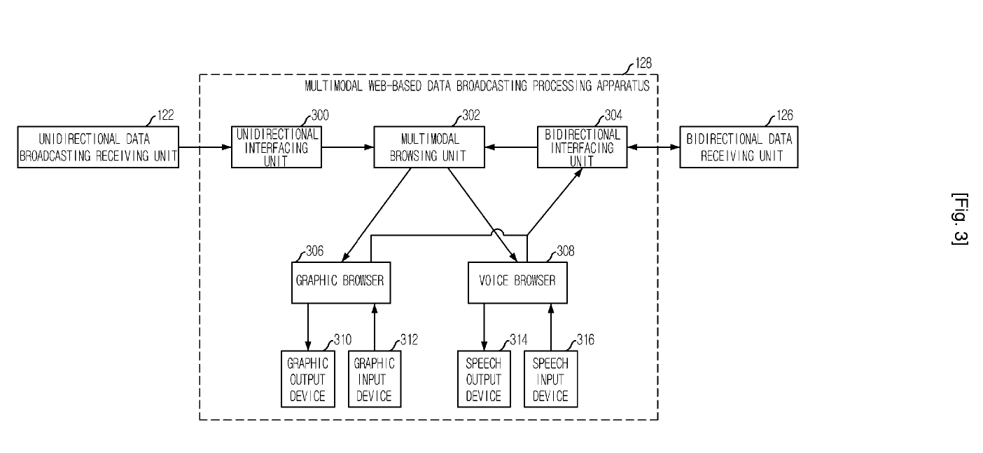

The unidirectional data broadcasting receiving unit 122 receives web-based contents commonly provided to users/viewers through a unidirectional broadcasting network. Particularly, the unidirectional data broadcasting receiving unit 122 receives web-based broadcasting data transmitted unidirectionally through digital broadcasting networks including a digital multimedia broadcasting network from a unidirectional data broadcasting server 100. Then, the unidirectional data broadcasting receiving unit 122 classifies the web-based broadcasting data into web-based content data and service information and, decodes the classified web-based content data and service information thereafter. The decoded service information is then transferred to the control unit 124, and the decoded web-based contents which corresponds to web documents that are generated as the web-based content data are decoded are transferred to the web-based data broadcasting processing apparatus 128, more particularly, to a unidirectional interfacing unit 300 in FIG. 3.

The bidirectional data receiving unit 126 receives customized multimodal web-based contents desired by specific users, i.e., the web documents, through a bidirectional network. Especially, the bidirectional data receiving unit 126 receives multimodal web-based contents transferred through various types of bidirectional networks such as a mobile telecommunication network, a public switched telephone network (PSTN), a local area network (LAN), an asymmetric digital subscriber line (ADSL) and the like from a bidirectional data broadcasting server 110 for providing bidirectional data broadcasting services.

In more detail, when a user demands customized web-based contents that are not transferred through the unidirectional broadcasting network, the bidirectional data receiving unit 126 transmits the user's command to the bidirectional data broadcasting server 110 through the selected aforementioned bidirectional network. Afterwards, the bidirectional data receiving unit 126 receives the customized web-based contents through the bidirectional network from the bidirectional data broadcasting server 110 and then, transfers the web-based contents, i.e., the customized web-based contents demanded by the users, to the web-based data broadcasting processing apparatus 128, more accurately to a bidirectional interfacing unit 304 shown in FIG. 3.

The multimodal web-based data broadcasting processing apparatus 128 receives and stores the web-based contents provided from the unidirectional data broadcasting receiving unit 122 and the bidirectional data receiving unit 126. Then, the multimodal web-based data broadcasting processing apparatus classifies the stored web-based contents into a voice part and a graphic part. Afterwards, on the basis of this classification, a graphic browser and a voice browser are correspondingly operated to output the classified web-based contents in the form of graphics and speech. The graphic/voice browser operation will be further described in detail in FIG. 3.

The control unit 124 serves an overall control function to provide the multimodal web-based data broadcasting services. In other words, the control unit 124 actuates and controls the unidirectional data broadcasting receiving unit 122, the bidirectional data receiving unit 126 and the multimodal web-based data broadcasting processing apparatus 128. Especially, the control unit 124 analyzes the service information (SI) transferred from the unidirectional data broadcasting receiving unit 122 and extracts specific pieces of service information corresponding to the web-based content data, for instance, multiplexing information, signaling information on an application program, object information and the like. Also, the control unit 124 reserves and manages necessary resources by using the extracted service information.

The multimodal web-based data broadcasting receiving system 120 receives the multimodal web-based contents to be provided commonly to all users through the unidirectional broadcasting network. On the other hand, through the bidirectional network, the multimodal web-based data broadcasting receiving system 120 receives bidirectional contents corresponding to customized web-based contents desired by specific users and provides the customized multimodal web-based data broadcasting services in the form of graphics and speech.

Also, in addition to the graphic-based web content services, the multimodal web-based data broadcasting receiving system 120 is capable of providing web-based content services such as an electronic program guide (EPG), top news, traffic information, advertisements, local information, mobile commerce service and education service in the form of speech as well.

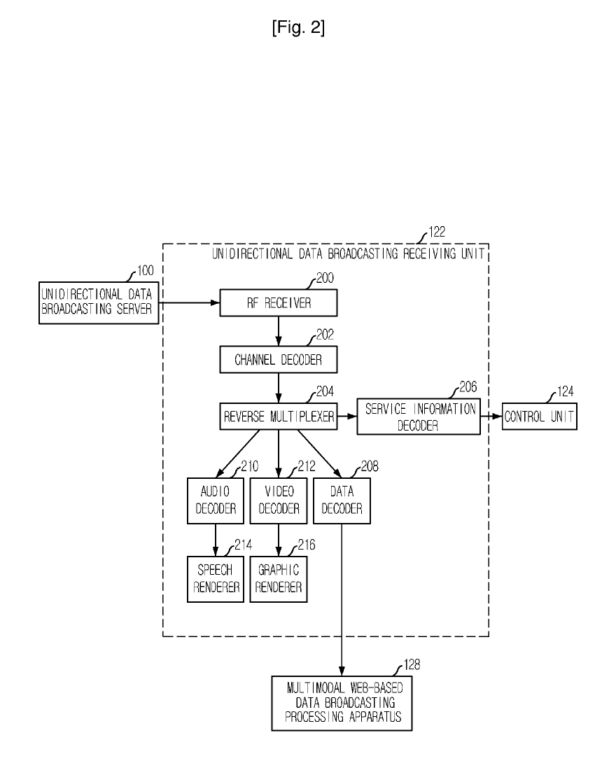

FIG. 2 is a configuration diagram showing the unidirectional data broadcasting receiving unit depicted in FIG. 1.

The unidirectional data broadcasting receiving unit 122 includes: a radio frequency (RF) receiver 200; a channel decoder 202; a reverse multiplexer 204; a service information decoder 206; a data decoder 208; an audio decoder 210; a video decoder 212; a speech renderer 214; and a graphic renderer 216.

The RF receiver 200 receives a web-based data broadcasting RF signal transmitted through the broadcasting network and demodulates the web-based data broadcasting RF signal into a baseband broadcasting signal. Then, the channel decoder 202 decodes the baseband broadcasting signal which is an output of the RF receiver 200.

The reverse multiplexer 204 separates service information and web-based content data from the decoded baseband broadcasting signal. The service information decoder 206 restores the separated service information which is subsequently transferred to the control unit 124. Meanwhile, the data decoder 208 decodes the separated web-based content data and transfers the decoded web-based content data to the multimodal web-based data broadcasting processing apparatus 128.

That is, the data decoder 208 decodes the web-based content data by using data and object carousels for a conventional digital broadcasting system and the multimedia object transfer (MOT) protocol for the digital multimedia broadcasting (DMB) system. Also, the data decoder 208 restores the web-based contents and a directory corresponding to an original object. Once the web-based contents are completely received, the data decoder 208 transfers the received web-based contents to the control unit 124.

When an audio signal and a video signal are transmitted together with the web-based data broadcasting RF signal provided from the unidirectional data broadcasting server 100, the reverse multiplexer 204 classifies the received signals into the audio signal, the video signal, the data, and the service information, and after the classification, the audio decoder 210 and the video decoder 212 decode the audio signal and the video signal, respectively. Thereafter, the speech renderer 214 and the graphic renderer 216 carries out a rendering process with respect to the decoded audio signal and the decoded video signal, respectively.

FIG. 3 is a configuration diagram showing the multimodal web-based data broadcasting processing apparatus depicted in FIG. 1.

The multimodal web-based data broadcasting processing apparatus 128 includes: a unidirectional interfacing unit 300; a multimodal browsing unit 302; a bidirectional interfacing unit 304; a graphic browser 306; a voice browser 308; a graphic output device 310; a graphic input device 312; a speech output device 314; and a speech input device 316.

The unidirectional interfacing unit 300 receives and stores web-based contents outputted from the unidirectional data broadcasting receiving unit 122. Also, when the web-based contents are updated, the unidirectional interfacing unit 300 checks and reflects the updated contents.

The bidirectional interfacing unit 304 transmits a request of a user, inputted through the graphic input device 312 and the graphic browser 306 or through the speech input device 316 and the speech browser 308, to the bidirectional data receiving unit 126. This request is transmitted from the bidirectional data receiving unit 126 to the bidirectional data broadcasting server 110 through the bidirectional network. Also, in response to the request from the user, the bidirectional interfacing unit 304 receives and stores the web-based contents transferred by the bidirectional data broadcasting server 110.

Then, the multimodal browsing unit 302 classifies the web-based contents, i.e., the web documents, stored at the unidirectional interfacing unit 300 or at the bidirectional interfacing unit 304 into a voice part and a graphic part. According to the classified voice part and graphic part, the graphic browser 306 and the voice browser 308 are correspondingly operated to output graphics and speech through the graphic output device 310 and the speech output device 316, respectively.

In other words, the multimodal browsing unit 302 performs a parsing activity with respect to the stored web-based contents and then classifies the web-based contents into contents necessary for running the graphic browser 306 and other contents necessary for running the voice browser 308. Afterwards, the multimodal browsing unit 302 interprets these classified web-based contents and then, depending on the interpretation, generates and transmits instructions and data necessary for correspondingly running the graphic browser 306 and the voice browser 308. Also, the multimodal browsing unit 302 synchronizes the graphic browser 306 and the voice browser 308 through an extensible markup language (XML) event processing function for the purpose of providing a synchronized service. That is, the multimodal browsing unit 302 performs both of the event processing function and the synchronization processing function. Furthermore, the multimodal browsing unit 302 controls and manages operations of the graphic browser 306 and the voice browser 308.

In addition, the multimodal browsing unit 302 classifies the web-based contents into the voice part, the graphic part and the event part based on name spaces. A detailed example of this classification is provided below.

<htmlxmlns=“http://www.w3.org/1999/xhtml”xmlns:ev=“http://www.w3.org/2001/xml-events”xmlns:vxml=“http:www.w3.org/2001/vxml”xml:lang=“en_US”>

Herein, the name spaces for identifying the graphic part, the voice part and the event part are ‘html xmlns’, ‘xmlns:vxml’ and ‘xmlns:ev’, respectively.

One example of the web-based contents in accordance with the preferred embodiment of the present invention is provided as follows. Particularly, the example is based on the specifications for XHTML and VoiceXML.

```
<?xml version=“1.0”?>
<html
xmlns=“http://www.w3.org/1999/xhtml”
xmlns:vxml=“http://www.w3.org/2001/vxml”
xmlns:ev=“http://www.w3.org/2001/xml-events”
xmlns:xv=“http://www.voicexml.org/2002/xhtml+voice”>
  <head>
  <title>XHTML+VoiceExample</title>
  <!?voice handler -->
  <vxml:form id=“sayHello”>
  <vxml:block><vxml:prompt xv:src=“#hello”/>
  </vxml:block>
  </vxml:form>
</head>
<body>
  <h1>XHTML+Voice Example</h1>
  <p id=“hello” ev:event=“click” ev:handler=“#sayHello”>
  Hello World!
  </p>
  </body>
</html>
```

Meanwhile, the graphic browser 306 generates a graphic output signal in response to the instructions and data transmitted from the multimodal browsing unit 302 for a graphic rendering process. The voice browser 308 generates a speech output signal in response to the instructions and data transmitted from the multimodal browsing unit 302 for a speech rendering process.

In more detail of the graphic browser 306 and the voice browser 308, the graphic browser 306 receives the data and instructions in regards of operation, stop, event, synchronization and so on from the multimodal browsing unit 302 and then, interprets the received instructions and data. According to the interpretation, the graphic browser 306 generates a graphic output signal. Also, through a graphic user interface (USI), the graphic browser 306 receives a request of a user inputted through the graphic input device 312 and then transmits this request to the bidirectional interfacing unit 304. Herein, identical to typical browsers, the graphic browser 306 has a graphic-based input/output interface.

Next, similar to the graphic browser 306, the voice browser 308 receives the instructions and data necessary for running the graphic browser 306 from the multimodal browsing unit 302 and interprets the received instructions and data. According to the interpretation, the voice browser 308 generates a speech output signal. Also, through a voice user interface (VUI), the voice browser 308 receives a request of a user inputted through the speech input device 316 and then transmits the received request to the bidirectional interfacing unit 304. Herein, the voice browser 308 has a speech recognition function, a text to speech (TTS) function for speech outputs and audio reproduction function in order to be compatible with the voice user interface.

The graphic output device 310 outputs graphics according to the graphic output signal generated by the graphic browser 306, while the speech output device 314 outputs speech according to the speech output signal generated by the voice browser 308.

The graphic input device 312 receives a request of a user and then transmits the inputted request to the graphic browser 306, while the speech input device 316 receives a request of a user and then transmits the inputted request to the voice browser 308.

As described above, FIG. 3 exemplifies the case of configuring the graphic browser 306 and the voice browser 308 separately, it is still possible to configure the graphic browser and the voice browser in integrated type.

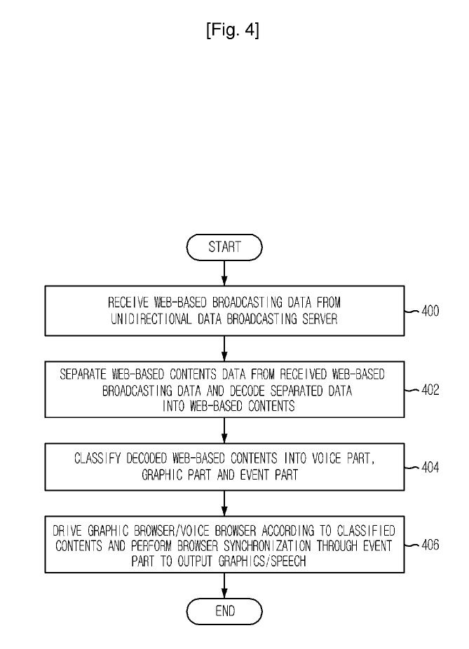

FIG. 4 is a flowchart describing a method for processing multimodal web-based data broadcasting incorporated with a graphic/voice user interface and a method for receiving multimodal web-based data broadcasting using the multimodal web-based data broadcasting processing method in accordance with the preferred embodiment of the present invention.

Although the multimodal web-based data broadcasting processing method and the multimodal web-based data broadcasting receiving method are explained already in the course of describing the multimodal web-based data broadcasting processing apparatus 128 and the multimodal web-based data broadcasting receiving system 120 shown in FIGS. 1 to 3, these two methods will be described in overall steps again. It should also be noted that the same reference numerals are used for the same configuration elements used in FIGS. 1 to 3.

At step S400, the unidirectional data broadcasting receiving unit 122 of the multimodal web-based data broadcasting receiving system 120 receives a web-based broadcasting data outputted from the unidirectional data broadcasting server 100. Afterwards, at step S402, based on the received web-based broadcasting data, the unidirectional data broadcasting receiving unit 122 classifies web-based content data which are, in turn, decoded into web-based contents.

In more detail of the unidirectional data broadcasting receiving steps S400 and S402, the unidirectional data broadcasting receiving unit 122 receives a web-based data broadcasting RF signal transmitted from the unidirectional data broadcasting server 100 and demodulates this received RF signal into a baseband broadcasting signal. Then, a channel decoding activity is applied to the baseband broadcasting signal. Afterwards, the unidirectional data broadcasting receiving unit 122 separates service information (SI) and web-based content data from the channel decoded baseband broadcasting signal. At this time, the reverse multiplexer 204 is used for the separation. These separated service information and web-based content data are restored through a decoding step.

Next, at step S404, the multimodal web-based data broadcasting processing apparatus 128 of the multimodal web-based data broadcasting receiving system 120 classifies the decoded web-based contents into a voice part, a graphic part and an event part. Based on this classification, at step S406, the multimodal web-based data broadcasting processing apparatus 128 runs the graphic browser 306 and the voice browser 308 correspondingly and obtains graphic/speech outputs. At this time, the multimodal web-based data broadcasting processing apparatus 128 synchronizes the graphic browser 306 and the voice browser 308 based on the event part.

Hereinafter, detailed description of the multimodal web-based data broadcasting processing steps S404 and S406 executed by the multimodal web-based data broadcasting processing apparatus 128 will be provided.

Through the use of the unidirectional interfacing unit 300, the multimodal web-based data broadcasting processing apparatus 128 receives and stores the web-based contents transferred from the unidirectional data broadcasting receiving unit 122, or through the use of the bidirectional interfacing unit 304, the multimodal web-based data broadcasting processing apparatus 128 receives and stores the web-based contents transferred from the bidirectional data receiving unit 126. Also, the multimodal web-based data broadcasting processing apparatus 128 performs a parsing activity with respect to the stored web-based contents and subsequently classifies the web-based contents into contents necessary for running the graphic browser 306 and other contents necessary for running the voice browser 308 and then, interprets the classified contents to generate instructions and data for running the corresponding graphic/voice browser 306 or 308. Afterwards, the multimodal web-based data broadcasting apparatus 128 generates a graphic/speech output signal according to the instructions and data and outputs graphics/speech depending on the graphic/speech output signal.

Although not illustrated in FIG. 4, the bidirectional data receiving unit 126 transmits a request of a user transmitted from the multimodal web-based data broadcasting processing apparatus 128 to the bidirectional data broadcasting server 110 through the bidirectional network or, receives the web-based contents corresponds to the request of the user transmitted from the bidirectional data broadcasting server 110 and then transmits the web-based contents to the multimodal web-based data broadcasting processing apparatus 128. As like the unidirectional data broadcasting, the web-based contents transferred in this described manner are processed by the multimodal web-based data broadcasting processing apparatus 128 to be outputted in the form of graphics and speech.

The above descried methods can be implemented as a program which can be stored into a computer readable recording medium such as a CD-ROM, a RAM, a ROM, a floppy disk, a hard disk, or a magneto-optical disk.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A multimodal data broadcasting processing apparatus incorporating with a graphic/voice user interface for data broadcasting, the multimodal data broadcasting processing apparatus comprising:
at least one interfacing means for receiving contents transferred from a data broadcasting server and storing the contents;
a multimodal browsing means for parsing the stored contents, classifying the contents into a graphic part and a voice part and interpreting the classified contents to generate instructions and data necessary for running a corresponding browsing means;
a graphic browsing means for generating a graphic output signal according to the instructions and data necessary for running the graphic browsing means;
a voice browsing means for generating a speech output signal according to the instructions and data necessary for running the voice browsing means;
a graphic output means for outputting graphics according to the graphic output signal; and
a speech output means for outputting speech according to the speech output signal.

2. The multimodal data broadcasting processing apparatus of claim 1, wherein the contents are transferred from a unidirectional data broadcasting server and a bidirectional data broadcasting server.

3. The multimodal data broadcasting processing apparatus of claim 1, further including a graphic/speech input means for receiving a request of a user and transmitting the request to one of the graphic browsing means and the voice browsing means.

4. The multimodal data broadcasting processing apparatus of claim 3, wherein the graphic/voice browsing means recognizes the request of the user inputted through the graphic/speech input means and transmits the request to a bidirectional interfacing means.

5. The multimodal data broadcasting processing apparatus of claim 3, wherein said at least one interfacing means transmits the request of the user inputted from the graphic/voice browsing means to a bidirectional data receiving means so that the request is transmitted to the bidirectional data broadcasting server.

6. The multimodal data broadcasting processing apparatus of claim 1, wherein the multimodal browsing means classifies the contents into contents necessary for running the graphic browsing means and contents necessary for running the voice browsing means by using name spaces.

7. The multimodal data broadcasting processing apparatus of claim 6, wherein the name spaces used for classifying the contents include a name space of ‘html xmlns’ for identifying the graphic part and a name space of ‘xmlns:vxml’ for identifying the voice part.

8. The multimodal data broadcasting processing apparatus of claim 7, wherein the multimodal browsing means classifies the stored contents further into an event part by using a name space of ‘xmlns:ev’ for identifying the event part and synchronizes the graphic browsing means and the voice browsing means by applying an extensible markup language (XML) event processing function.

9. A multimodal data broadcasting receiving system incorporating with a graphic/voice user interface, comprising:
a unidirectional data broadcasting receiving means for receiving a broadcasting data from an external source, separating content data from the broadcasting data and decoding the separated content data to restore contents;
a multimodal data broadcasting processing means for classifying the contents into a voice part and a graphic part and running a corresponding graphic/voice browsing means to output graphics/speech; and
a first control means for controlling the unidirectional data broadcasting receiving means and the multimodal data broadcasting processing means to provide unidirectional data broadcasting services.

10. The multimodal data broadcasting receiving system of claim 9, further including:
a bidirectional data receiving means for transmitting a request of a user inputted from the multimodal data broadcasting processing means to a bidirectional data broadcasting server through a bidirectional network, receiving user-requested contents from the bidirectional data broadcasting server and transferring the contents to the multimodal data broadcasting processing means; and
a second control means for controlling the bidirectional data receiving means and the multimodal data broadcasting processing means to provide bidirectional data broadcasting services.

11. The multimodal data broadcasting receiving system of claim 9, wherein the unidirectional data broadcasting receiving means includes:
a radio frequency (RF) receiving means for receiving a data broadcasting RF signal inputted from an external source and demodulating the data broadcasting RF signal into a baseband broadcasting signal;
a channel decoding means for performing a channel decoding activity to the decoded baseband broadcasting signal;
a reverse multiplexing means for performing a reverse multiplexing activity to separate service information and content data from the channel decoded baseband broadcasting signal;
a service information decoding means for restoring the service information separated by the reverse multiplexing means; and
a data decoding means for decoding the content data separated by the reverse multiplexing means into the contents.

12. The multimodal data broadcasting receiving system of claim 11, wherein the multimodal data broadcasting processing means includes:
a unidirectional interfacing means for receiving the contents transferred from the unidirectional data broadcasting receiving means and storing the contents;
a bidirectional interfacing means for receiving the contents transferred from the bidirectional data receiving means and storing the contents;
a multimodal browsing means for parsing the stored contents, classifying the contents into a graphic part and a voice part and interpreting the classified contents to output instructions and data necessary for running a corresponding browsing means;
a graphic browsing means for generating a graphic output signal according to the instructions and data necessary for running the graphic browsing means;
a voice browsing means for generating a speech output signal according to the instructions and data necessary for running the voice browsing means;
a graphic output means for outputting graphics according to the graphic output signal; and
a speech output means for outputting speech according to the speech output signal.

13. The multimodal data broadcasting receiving system of claim 12, further including a graphic/speech input means for transmitting a request of a user to one of the graphic browsing means and the voice browsing means.

14. The multimodal data broadcasting receiving system of claim 13, wherein the graphic/voice browsing means recognizes the request transmitted through the graphic/speech input means and transmits the request to the bidirectional interfacing means.

15. The multimodal data broadcasting receiving system of claim 13, wherein the bidirectional interfacing means transmits the request inputted from the graphic/voice browsing means to the bidirectional data receiving means.

16. A method for processing multimodal data broadcasting incorporated with a graphic/voice user interface, the method comprising the steps of:
(a) receiving and storing contents transmitted from the a data broadcasting server;
(b) parsing the stored contents, classifying the contents into a graphic part and a voice part and interpreting the classified contents to generate instructions and data necessary for running a corresponding graphic/voice browsing means;
(c) generating a graphic output signal by employing the graphic browsing means according to the instructions and data necessary for running the graphic browsing means;
(d) generating a speech output signal by employing the voice browsing means according to the instructions and data necessary for running the voice browsing means;
(e) outputting graphics according to the graphic output signal; and
(f) outputting speech according to the speech output signal.

17. The method of claim 16, wherein the contents are transferred from a unidirectional data broadcasting server and from a bidirectional data broadcasting server.

18. The method of claim 16, wherein at the step of (b), the contents are classified into contents necessary for running the graphic browsing means and contents necessary for running the voice browsing means by using name spaces.

19. The method of claim 18, wherein the name spaces used for classifying the contents include a name space of ‘html xmlns’ for identifying the graphic part and a name space of ‘xmlns:vxml’ for identifying the voice part.

20. The method of claim 19, wherein at the step of (b), the contents are further classified into an event part by using a name space of ‘xmlns:ev’ for identifying the event part and the graphic browsing means and the voice browsing means are synchronized by applying an XML event processing function.

21. A method for receiving multimodal data broadcasting incorporated with a graphic/voice user interface, the method comprising the steps of:
(a) receiving a broadcasting data inputted from a unidirectional data broadcasting server, classifying the broadcasting data into content data and decoding the content data to restore contents; and
(b) classifying the contents into a voice part and a graphic part and running a corresponding graphic/voice browsing means according to the classified contents to output graphics/speech.

22. The method of claim 21, further including the step (c) of transmitting a request of a user made at the step (b) to a bidirectional data broadcasting server through a bidirectional network and receiving user requested contents from the bidirectional data broadcasting server.

23. The method of claim 21, wherein the step (a) includes the steps of:
(a-1) receiving a broadcasting RF signal inputted from an external source and demodulating the RF signal into a baseband broadcasting signal;
(a-2) performing a channel decoding activity to the demodulated baseband broadcasting signal;
(a-3) separating service information and content data from the channel decoded baseband broadcasting signal through a reverse multiplexing activity;
(a-4) restoring the service information separated by the reverse multiplexing activity; and
(a-5) decoding the content data separated by the reverse multiplexing activity into the contents.

24. The method of claim 23, wherein the step (b) includes the steps of:
(b-1) receiving the contents decoded at the step (a) and storing the received contents;
(b-2) receiving the contents inputted at the step (c) and storing the contents;
(b-3) parsing the stored contents, classifying the contents into a graphic part and a voice part and interpreting the classified contents to generate instructions and data necessary for running a corresponding graphic/voice browsing means;
(b-4) generating a graphic output signal by employing the graphic browsing means according to the instructions and data necessary for running the graphic browsing means;
(b-5) generating a speech output signal by employing the voice browsing means according to the instructions and data necessary for running the voice browsing means;
(b-6) outputting graphics according to the graphic output signal; and
(b-7) outputting speech according to the speech output signal.

25. The method of claim 24, wherein the step (b) further includes the steps of:
(b-8) receiving a request of a user and transmitting the request to one of the graphic browsing means and the voice browsing means; and
(b-9) recognizing the request through employing the graphic/voice browsing means and transmitting the request to the bidirectional data broadcasting server.
